(19) United States
(12) Patent Application Publication
(10) Pub. No.: US 2026/0088015 A1
(43) Pub. Date: Mar. 26, 2026

(54) SPEECH SYNTHESIS DEVICE, SPEECH SYNTHESIS METHOD, AND COMPUTER PROGRAM PRODUCT

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventors: Yoshiki HIRUTA, Hachioji Tokyo (JP); Masatsune TAMURA, Kawasaki Kanagawa (JP)

(73) Assignees: KABUSHIKI KAISHA TOSHIBA, Kawasaki-shi (JP); TOSHIBA DIGITAL SOLUTIONS CORPORATION, Kawasaki-shi (JP)

(21) Appl. No.: 19/407,471

(22) Filed: Dec. 3, 2025

Related U.S. Application Data
(63) Continuation of application No. PCT/JP2024/033416, filed on Sep. 19, 2024.

(30) Foreign Application Priority Data
Sep. 19, 2023 (JP) 2023-151546

(51) Int. Cl. G10L 13/047; G10L 25/30

(52) U.S. Cl. CPC G10L 13/047; G10L 25/30

(57) ABSTRACT

A speech synthesis device according to an embodiment includes a memory and a hardware processor connected to the memory. The processor executes encoder processing with a first neural network to convert attribute information of a speech unit into an intermediate representation. The processor executes decoder processing with a second neural network to generate an acoustic feature from the intermediate representation. The processor executes adjustment processing by using an adjustment dictionary in which at least the attribute information of the speech unit is set as a key and an adjustment instruction to the acoustic feature is set as a value. The processor executes the adjustment processing by defining, by the key, a section to which the adjustment instruction is applied, and adjusting the acoustic feature in the defined section based on the adjustment instruction.

### CROSS-REFERENCE TO RELATED APPLICATIONS

This application is based upon and claims the benefit of priority from Japanese Patent Application No. 2023-151546, filed on Sep. 19, 2023 and International Patent Application No. PCT/JP2024/033416 filed on Sep. 19, 2024; the entire contents of all of which are incorporated herein by reference.

### FIELD

Embodiments described herein relate generally to a speech synthesis device, a speech synthesis method, and a computer program product.

### BACKGROUND

Recent speech synthesis technologies have achieved synthetic speech with high sound quality near that of human speech by using a deep neural network (DNN).

On the other hand, as one of limits to machine learning, synthetic speech is synthesized with an incorrect pronunciation or unnatural prosody in some cases. Therefore, “adjustment” for correcting such problems is necessary in order to improve product quality.

In the conventional HMM speech synthesis technologies, adjustment can be efficiently performed by, for example, the speech synthesis dictionary modification device disclosed in JP 2014-174278 A. In DNN speech synthesis, for example, JP 2022-81691 A proposes a speech synthesis device capable of obtaining a high-quality synthetic speech signal when generating a synthetic speech signal that has adjusted the reading of a specific portion of the text.

However, in the conventional technologies, it is difficult to adjust synthetic speech more efficiently for a similar adjustment area in DNN speech synthesis.

### BRIEF DESCRIPTION OF THE DRAWINGS

FIG. 1 is a diagram illustrating an example of a functional configuration of a speech synthesis device according to a first embodiment;

FIG. 2 is a diagram illustrating an example of a functional configuration of an adjusting unit according to the first embodiment;

FIG. 3 is a flowchart illustrating an example of an overall procedure of a speech synthesis method according to the first embodiment;

FIG. 4 is a flowchart illustrating an example of a detailed procedure of adjustment processing (step S4 in FIG. 3) of duration according to the first embodiment;

FIG. 5 is a diagram illustrating an example of the adjustment of the duration according to the first embodiment;

FIG. 6 is a flowchart illustrating an example of a detailed procedure of adjustment processing (step S6 in FIG. 3) of an acoustic feature (in the case of a logarithmic fundamental frequency) according to the first embodiment;

FIG. 7 is a diagram illustrating an example of the adjustment of the logarithmic fundamental frequency according to the first embodiment;

FIG. 8 is a diagram illustrating an example of a functional configuration of a speech synthesis device according to a second embodiment;

FIG. 9 is a diagram illustrating an example of a functional configuration of an index acquiring unit according to the second embodiment;

FIG. 10 is a diagram illustrating an example of a functional configuration of an adjusting unit according to the second embodiment;

FIG. 11 is a flowchart illustrating an example of an overall procedure of a speech synthesis method according to the second embodiment;

FIG. 12 is a flowchart illustrating an example of a detailed procedure of acquisition processing (step S23 in FIG. 11) of a cluster number according to the second embodiment;

FIG. 13 is a flowchart illustrating an example of a detailed procedure of adjustment processing (step S25 in FIG. 11) of duration according to the second embodiment;

FIG. 14 is a flowchart illustrating an example of a detailed procedure of adjustment processing (step S27 in FIG. 11) of an acoustic feature (in the case of a logarithmic fundamental frequency) according to the second embodiment;

FIG. 15 is a diagram illustrating an example of a functional configuration of a speech synthesis device according to a third embodiment;

FIG. 16 is a diagram illustrating an example of a functional configuration of an acoustic feature decoder according to the third embodiment;

FIG. 17 is a diagram illustrating an example of a functional configuration of an adjusting unit according to the third embodiment;

FIG. 18 is a flowchart illustrating an example of an overall procedure of a speech synthesis method according to the third embodiment;

FIG. 19 is a flowchart illustrating an example of a detailed procedure of adjustment processing (step S38 in FIG. 18) of an intermediate representation sequence according to the third embodiment;

FIG. 20 is a diagram illustrating an example of a spectrum of synthetic speech in a case where the intermediate representation sequence has been adjusted through adjustment processing (step S38 in FIG. 18) according to the third embodiment; and

FIG. 21 is a diagram illustrating an example of a hardware configuration of the speech synthesis devices according to the first to third embodiments.

### DETAILED DESCRIPTION

A speech synthesis device according to an embodiment includes a memory and a hardware processor connected to the memory. The hardware processor is configured to execute encoder processing with a first neural network to convert attribute information of a speech unit into an intermediate representation. The hardware processor is configured to execute decoder processing with a second neural network to generate an acoustic feature from the intermediate representation. The hardware processor is configured to execute adjustment processing. The adjustment processing is executed by using an adjustment dictionary in which at least the attribute information of the speech unit is set as a key and an adjustment instruction to the acoustic feature is set as a value. The adjustment processing is executed by defining, by the key, a section to which the adjustment instruction is applied, and adjusting the acoustic feature in the defined section based on the adjustment instruction.

Hereinafter, embodiments of a speech synthesis device, a speech synthesis method, and a computer program product will be described in detail with reference to the accompanying drawings.

### First Embodiment

First, an outline of a speech synthesis device according to a first embodiment will be described.

### Outline of Speech Synthesis Device 1

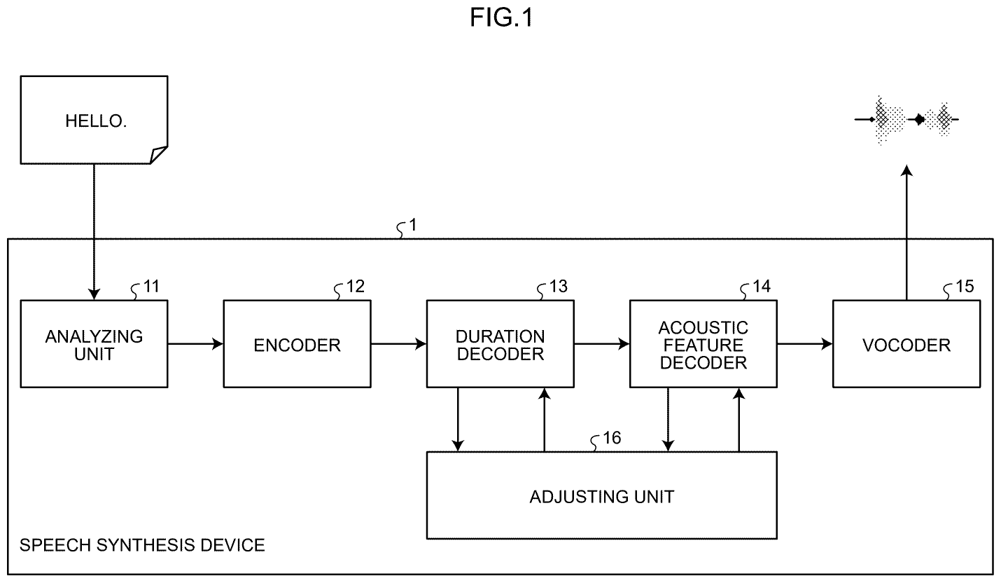

FIG. 1 is a diagram illustrating an example of a functional configuration of a speech synthesis device 1 according to the first embodiment. The speech synthesis device 1 according to the first embodiment includes an analyzing unit 11, an encoder 12, a duration decoder 13, an acoustic feature decoder 14, a vocoder 15, and an adjusting unit 16.

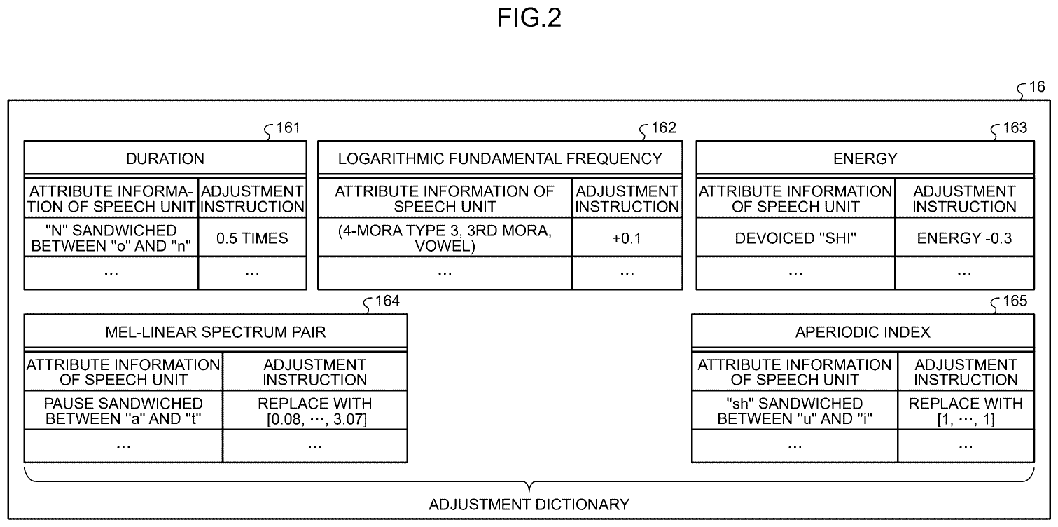

In the speech synthesis device 1 according to the first embodiment, the duration and each acoustic feature are adjusted by the adjusting unit 16, and a speech waveform is generated by the vocoder 15 from the adjusted acoustic features. The adjusting unit 16 includes preliminarily created adjustment dictionaries 161, 162, 163, 164, and 165 (FIG. 2) of duration and each acoustic feature, and adjusts the duration and each acoustic feature by using these adjustment dictionaries. A key and value of an entry of the adjustment dictionaries of duration and each acoustic feature are attribute information of a speech unit and an adjustment instruction, respectively. This makes it possible to obtain appropriate synthetic speech without causing the user to perform the same adjustment to the similar problem many times.

Details of each functional block will be described below.

The analyzing unit 11 analyzes an input text and outputs the attribute information of each speech unit. The speech unit is, for example, a mora or phoneme in Japanese. The attribute information is a set of linguistic information and phonetic information of the speech unit. The attribute information includes, for example, previous and following speech unit types, an accent type and a relative position in an accent phrase, part of speech information, and the like.

The encoder 12 (an example of the encoder processing) receives the vector representation of the attribute information of each speech unit as the input, and outputs a sequence of an intermediate representation (hereinafter referred to as an “intermediate representation sequence”) of a neural network. The intermediate representation is a latent representation having information for finally obtaining the speech waveform, but is generally difficult to interpret by a human. In the first embodiment, the attribute information of each speech unit and each intermediate representation correspond to each other on a one-to-one basis.

The duration decoder 13 receives the intermediate representation sequence as the input, and outputs the duration (duration time) by using the neural network. The duration is the number of frames of the acoustic feature corresponding to each speech unit. The frame is a waveform unit cut out when analyzing and synthesizing the speech waveform, and is determined by a fixed length or a length based on a pitch period.

The acoustic feature decoder 14 (an example of the decoder processing) receives the intermediate representation sequence as the input, and outputs the acoustic features based on the duration by using the neural network. In the first embodiment, a logarithmic fundamental frequency, energy, a spectral feature, a voicing/devoicing flag, and an aperiodic index are used as the acoustic features. The logarithmic fundamental frequency uses a value interpolated by using values of preceding and following voicing portions in a devoicing portion. Hereinafter, in the present specification, a mel-linear spectrum pair is used as the spectral feature, but other spectral features such as a mel cepstrum, a mel spectrogram, or an intermediate representation of machine-learned spectral information may be used.

Note that the duration may be treated as one of the acoustic features, and the duration decoder 13 and the acoustic feature decoder 14 may be implemented by a single acoustic feature decoder.

The vocoder 15 generates the speech waveform from the acoustic features. The vocoder 15 generates the speech waveform by, for example, the signal processing method described in M. Morise, F. Yokomori, and K. Ozawa, “WORLD: a vocoder-based high-quality speech synthesis system for real-time applications,” IEICE transactions on information and systems, vol. E99-D, no. 7, pp. 1877-1884, 2016. In addition, for example, the vocoder 15 may generate the speech waveform by using the neural network described in A. Tamamori, T. Hayashi, K. Kobayashi, K. Takeda and T. Toda, “Speaker-Dependent WaveNet Vocoder. Proc.” Proc. Interspeech 2017, pp. 1118-1122, 2017.

Next, the adjusting unit 16 that is a feature of the first embodiment will be described with reference to FIG. 2. FIG. 2 is a diagram illustrating an example of a functional configuration of the adjusting unit 16 according to the first embodiment. The adjusting unit 16 includes a duration adjustment dictionary 161, a logarithmic fundamental frequency adjustment dictionary 162, an energy adjustment dictionary 163, a mel-linear spectrum pair adjustment dictionary 164, and an aperiodic index adjustment dictionary 165.

The key and the value of the entry of the adjustment dictionary of duration and each acoustic feature are the attribute information of the speech unit and the adjustment instruction, respectively. The adjusting unit 16 refers to the adjustment dictionaries of duration and each acoustic feature during speech synthesis, defines a section to which the adjustment instruction is applied by using the key of each entry, and adjusts the acoustic features in the defined section based on the adjustment instruction.

### Processing of Speech Synthesis Device 1

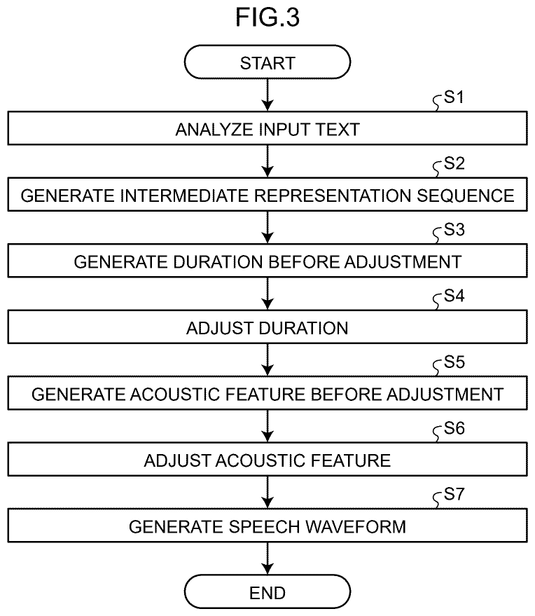

FIG. 3 is a flowchart illustrating an example of an overall procedure of a speech synthesis method according to the first embodiment. First, the analyzing unit 11 analyzes the input text and outputs the attribute information of each speech unit (step S1). In one example, the analyzing unit 11 performs morphological analysis on the input text and obtains linguistic information to be used for speech synthesis such as pronunciation information and accent information. Thereafter, the analyzing unit 11 outputs the attribute information of each speech unit from the obtained pronunciation information and linguistic information. Alternatively, the analyzing unit 11 may create the attribute information of each speech unit from corrected pronunciation/accent information corresponding to a separately created input text.

Subsequently, the encoder 12 generates the intermediate representation sequence from the vector representation of the attribute information of each speech unit (step S2). Then, the duration decoder 13 generates the duration before adjustment from the intermediate representation sequence (step S3).

The adjusting unit 16 adjusts the duration before adjustment obtained in step S3 based on the attribute information of each speech unit (step S4).

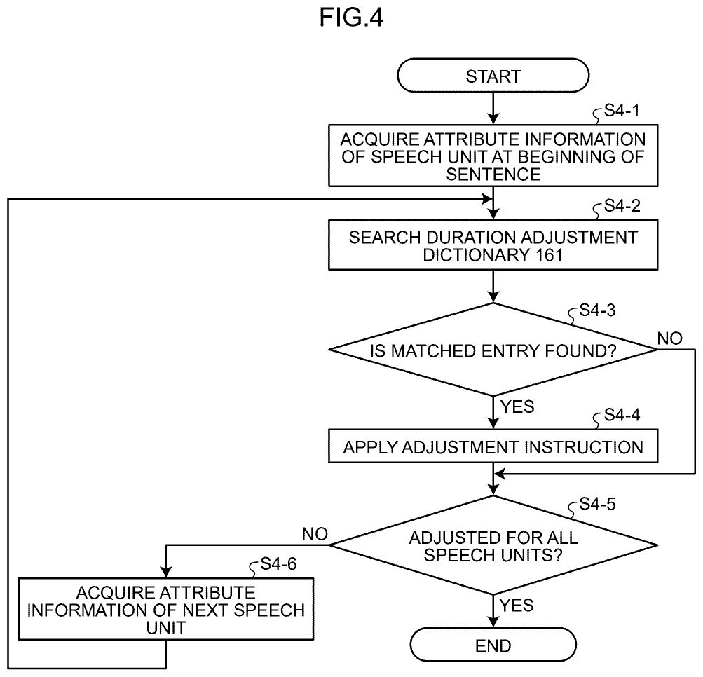

FIG. 4 is a flowchart illustrating an example of a detailed procedure of the adjustment processing (step S4 in FIG. 3) of the duration according to the first embodiment. First, the adjusting unit 16 acquires the attribute information of the speech unit at the beginning of the sentence (step S4-1), and searches the duration adjustment dictionary 161 for an entry in which the attribute information of the speech unit that is the key is matched (step S4-2).

If a matched entry is found (Yes in step S4-3), the adjusting unit 16 applies the adjustment instruction of the entry to the duration corresponding to the attribute information of the speech unit acquired in step S4-1 (step S4-4). If no matched entry is found (No in step S4-3), the processing proceeds to step S4-5.

When the adjustment has been completed for all the speech units (Yes in step S4-5), the processing ends. If the adjustment has not been completed for all the speech units (No in step S4-5), the adjusting unit 16 acquires the attribute information of the next speech unit (step S4-6), and performs the processing from step S4-2.

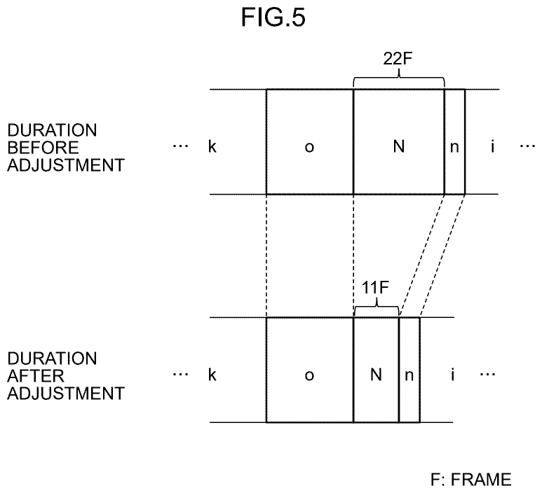

FIG. 5 illustrates an example of a duration adjusted in step S4. FIG. 5 is a diagram illustrating an example of the adjustment of the duration according to the first embodiment. FIG. 5 illustrates the example of the adjustment of the duration in a case where the speech unit is a phoneme and a sentence “ko-N-ni-chi-wa.” in Japanese language (corresponding to “Hello” in English language) is input. Since the input sentence includes “N” sandwiched between the vowel “o” and the consonant “n,” the first entry of the duration adjustment dictionary 161 is found in step S4-2. Therefore, in step S4-4, the adjustment instruction to multiply the duration by 0.5 that is the value of the entry is applied. By the adjustment, the duration is multiplied by 0.5 and changed from 22 frames (“22F”) to 11 frames (“11F”).

Returning to FIG. 3 again, next, the acoustic feature decoder 14 generates each acoustic feature before adjustment from the intermediate representation sequence based on the duration after adjustment (step S5). Next, the adjusting unit 16 adjusts each acoustic feature from each acoustic feature before adjustment and the attribute information of each speech unit (step S6).

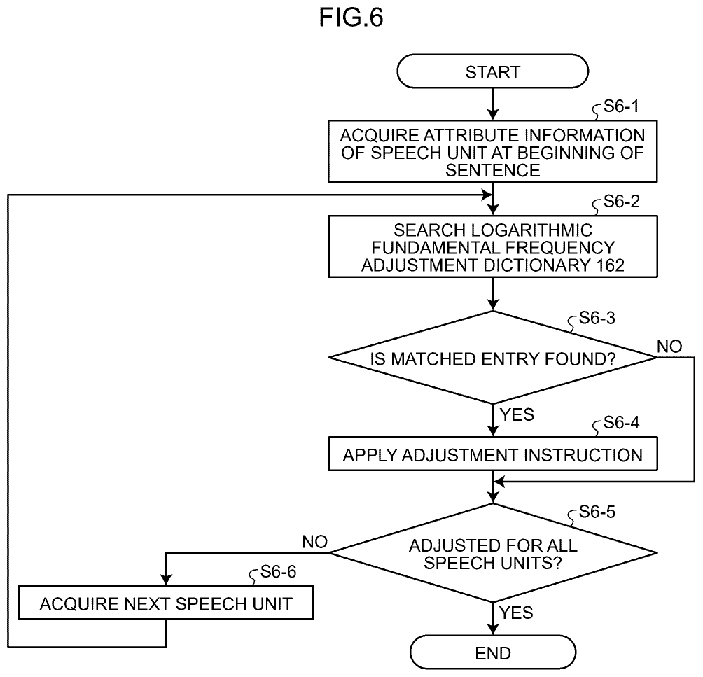

As an example, FIG. 6 illustrates details on the adjustment method of the logarithmic fundamental frequency. FIG. 6 is a flowchart illustrating an example of a detailed procedure of the adjustment processing (step S6 in FIG. 3) of the acoustic feature (in the case of the logarithmic fundamental frequency) according to the first embodiment. First, the adjusting unit 16 acquires the attribute information of the speech unit at the beginning of the sentence (step S6-1), and searches the logarithmic fundamental frequency adjustment dictionary 162 for an entry in which the attribute information of the speech unit that is the key is matched (step S6-2).

If a matched entry is found (Yes in step S6-3), the adjusting unit 16 applies the adjustment instruction of the entry to the section corresponding to the attribute information of the speech unit acquired in step S6-1 (step S6-4). If no matched entry is found (No in step S6-3), the processing proceeds to step S6-5.

When the adjustment has been completed for all the speech units (Yes in step S6-5), the processing ends. If the adjustment has not been completed for all the speech units (No in step S6-5), the adjusting unit 16 acquires the attribute information of the next speech unit (step S6-6), and performs the processing from step S6-2.

Note that the adjusting unit 16 also adjusts acoustic features other than the logarithmic fundamental frequency through the same processing as that in FIG. 6.

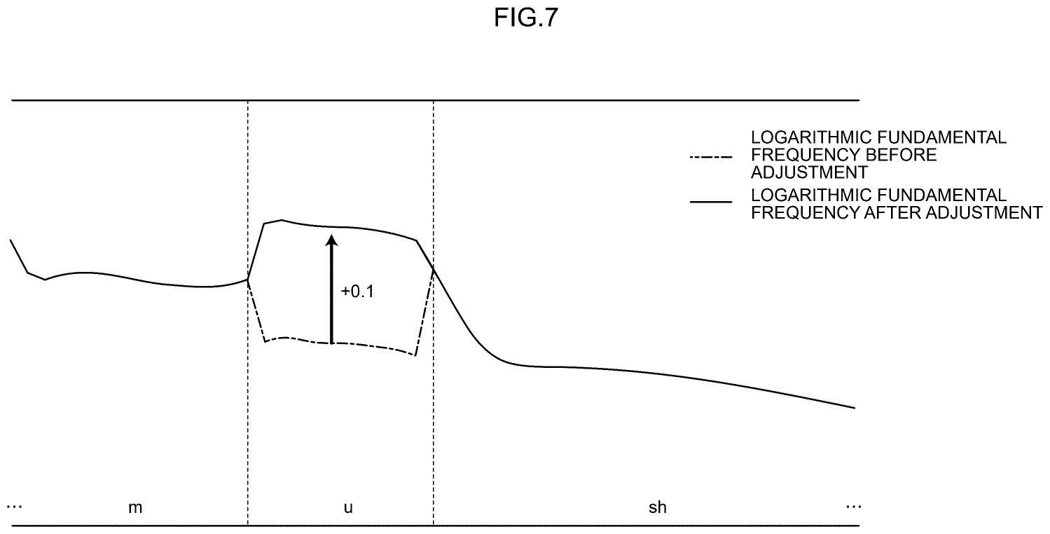

FIG. 7 illustrates an example of the logarithmic fundamental frequency adjusted in step S6. FIG. 7 is a diagram illustrating an example of the adjustment of the logarithmic fundamental frequency according to the first embodiment. FIG. 7 illustrates an example of the adjustment in a case where the speech unit is a phoneme, “ke-i-mu-sho.” in Japanese language (corresponding to “prison” in English language) is the input sentence, and the input sentence is analyzed by the analyzing unit 11 as a sentence having an accent type called 4-mora type 3. In this case, since the vowel “u” of the third mora “mu” of the input sentence is included, the first entry of the logarithmic fundamental frequency adjustment dictionary 162 is found in step S6-2. Therefore, in step S6-4, the adjustment instruction to add+0.1 to the logarithmic fundamental frequency that is the value of the entry is applied. As illustrated in FIG. 7, the logarithmic fundamental frequency of the section corresponding to the vowel “u” of “mu” is increased by +0.1.

Returning to FIG. 3 again, finally, the vocoder 15 generates the speech waveform from the acoustic features after adjustment obtained in step S6 (step S7). The speech waveform generated in step S7 can be optionally used by the user. For example, the speech waveform generated in step S7 may be reproduced by the user in a sound reproduction device (for example, a speaker) outside the speech synthesis device 1, or may be stored in a storage device outside the speech synthesis device 1.

As described above, the speech synthesis device 1 according to the first embodiment includes the adjusting unit 16 that adjusts the duration and each acoustic feature. The adjusting unit 16 includes the preliminarily created adjustment dictionaries of duration and each acoustic feature, and adjusts the duration and each acoustic feature by using these adjustment dictionaries during speech synthesis. The key and the value of the entry of the adjustment dictionaries of duration and each acoustic feature are the attribute information of the speech unit and the adjustment instruction, respectively. The speech synthesis device 1 adjusts the duration and each acoustic feature at the adjusting unit 16 and generates the speech waveform at the vocoder 15 from the adjusted acoustic features, thereby making it possible to obtain appropriate synthetic speech without causing the user to perform the same adjustment on the similar problem many times.

### Details of Each Part of Speech Synthesis Device 1

The adjustment instruction applied by the adjusting unit 16 is an operation for correcting each problem. The problem is corrected by applying an operation of multiplying the duration by a specified value and an operation of adding a specified value to the logarithmic fundamental frequency and the energy. In addition, for example, the problem is corrected by applying an operation of replacing with a specified vector to the mel-linear spectrum pair and the aperiodic index that are multi-dimensional acoustic features. The vector may be specified by directly specifying the vector or creating a list of replacement destination vectors and specifying an index thereof. In the latter case, during the adjustment, the adjusting unit 16 may read the vector of the corresponding index from the list of the replacement destination vectors and replace each acoustic feature in the adjustment area.

Each neural network used in the speech synthesis device 1 according to the first embodiment is learned by a statistical method. During learning, each neural network may be simultaneously learned. For example, the neural networks used in the encoder 12, the duration decoder 13, and the acoustic feature decoder 14 may be simultaneously learned. In addition, in a case where a neural network is used in the vocoder 15, the neural network may be learned by the statistical method as described above, and may be learned by the statistical method simultaneously with the other neural networks used in the speech synthesis device 1.

An example of a method of adding a new entry to the adjustment dictionaries 161, 162, 163, 164, and 165 of duration and each acoustic feature will be described. First, the speech synthesis device 1 of the first embodiment synthesizes speech from an optional input text. Subsequently, an adjuster (for example, a vendor developer or the like) of the speech synthesis device 1 listens to the synthetic speech obtained by the speech synthesis device 1, and confirms whether there is a problem.

If there is the problem, the adjuster identifies the area where the problem has occurred and the duration or acoustic feature causing the problem, and determines an adjustment instruction for obtaining appropriate synthetic speech.

Subsequently, from the attribute information of the speech unit in the area where the identified problem has occurred, the adjuster determines the attribute information that can define the section to which the adjustment instruction is appropriately applied such that the adjustment can be performed in step S4 or step S6 when the same problem occurs and the adjustment instruction is not applied in step S4 or step S6 when the problem does not occur.

Then, in response to an operation input of the adjuster, the speech synthesis device 1 according to the first embodiment adds an entry having the attribute information determined by the adjuster as the key and the adjustment instruction determined by the adjuster as the value, to the adjustment dictionary corresponding to the duration or the acoustic feature that has caused the problem.

### Effects of Speech Synthesis Device 1 of First Embodiment

In the speech synthesis device 1 that converts the attribute information of the speech unit into the intermediate representation and generates the acoustic features by using the encoder-decoder type neural network, it is possible to provide the speech synthesis device 1 that does not need to perform the same adjustment many times on a problem occurring under the same condition.

Specifically, as described above, in the speech synthesis device 1 according to the first embodiment, the encoder 12 converts the attribute information of the speech unit into the intermediate representation by using a first neural network. The decoder (the duration decoder 13 and the acoustic feature decoder 14 in the first embodiment) generates the acoustic features from the intermediate representation by using a second neural network. Using the adjustment dictionary (see FIG. 2) having at least the attribute information of the speech unit as the key and the adjustment instruction to the acoustic feature as the value, the adjusting unit 16 defines, by the key, a section to which the adjustment instruction is applied, and adjusts the acoustic feature in the defined section based on the adjustment instruction.

According to the speech synthesis device 1 of the first embodiment, it is possible to adjust the synthetic speech more efficiently for the similar adjustment area. This makes it possible to obtain appropriate synthetic speech without causing the adjuster to perform the same adjustment to the similar problem many times. In the conventional DNN speech synthesis technologies, since the user needs to input the adjustment amount each time, it takes time and effort to input the same adjustment amount many times for the similar adjustment area.

### Second Embodiment

Next, a second embodiment will be described. In the description of the second embodiment, the same description as that of the first embodiment will be omitted, and parts different from the first embodiment will be described.

### Outline of Speech Synthesis Device 2

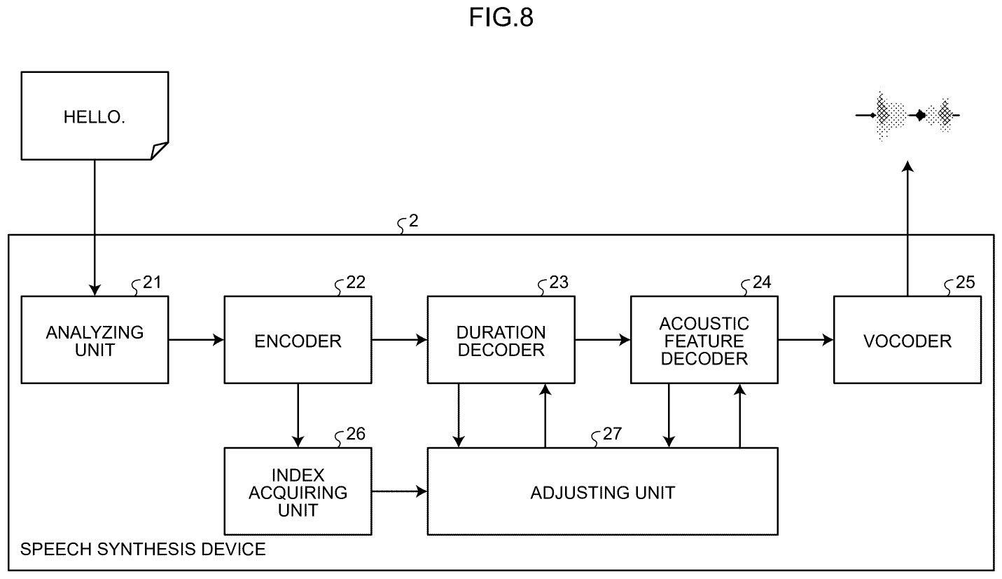

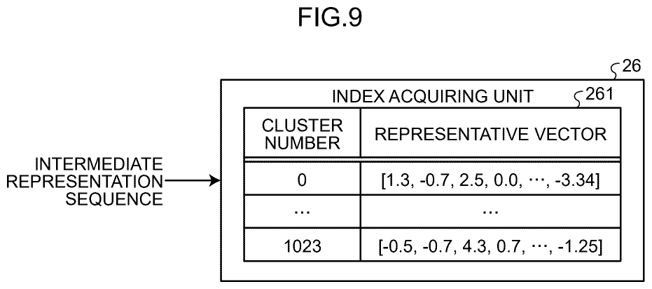

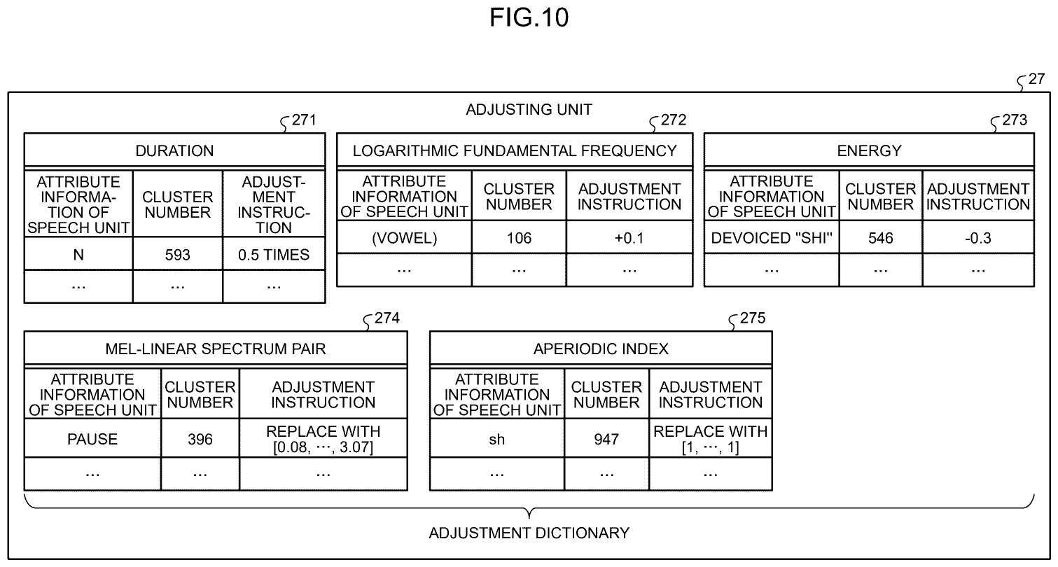

FIG. 8 is a diagram illustrating an example of a functional configuration of a speech synthesis device 2 according to a second embodiment. The speech synthesis device 2 according to the second embodiment includes an adjusting unit 27 that adjusts the duration and the acoustic feature based on adjustment dictionaries 271, 272, 273, 274, and 275 (FIG. 10) of duration and each acoustic feature in which information identifying the intermediate representation acquired by an index acquiring unit 26 (FIG. 9) is also the key, in addition to the attribute information of the speech unit. In the second embodiment, it is possible to specify the section to which appropriate adjustment is applied without specifying in detail the attribute information of the speech unit. For the information identifying the intermediate representation, a number (an example of an index) obtained by a machine learning model to which the intermediate representation is input, specifically, a cluster number obtained when the intermediate representation is classified by a clustering model is used. By using the cluster number, the interpretability of the key is improved while the key is kept compact.

Details of each functional block will be described below.

The speech synthesis device 2 according to the second embodiment is different from the speech synthesis device 1 according to the first embodiment in that the speech synthesis device 2 includes the index acquiring unit 26. In addition, similarly to the speech synthesis device 1 according to the first embodiment, the speech synthesis device 2 according to the second embodiment includes an analyzing unit 21, an encoder 22, a duration decoder 23, an acoustic feature decoder 24, a vocoder 25, and the adjusting unit 27.

Next, the index acquiring unit 26 that is one of technical features of the second embodiment will be described with reference to FIG. 9. FIG. 9 is a diagram illustrating an example of a functional configuration of the index acquiring unit 26 according to the second embodiment. The index acquiring unit 26 outputs the cluster number obtained when each intermediate representation output from the encoder 22 is classified by the clustering model. The index acquiring unit 26 includes a list 261 of representative vectors of clusters obtained from the preliminarily learned clustering model.

FIG. 10 is a diagram illustrating an example of a functional configuration of the adjusting unit according to the second embodiment. The adjusting unit 27 according to the second embodiment includes the adjustment dictionaries 271, 272, 273, 274, and 275 of duration and each acoustic feature (logarithmic fundamental frequency, energy, a mel-linear spectrum pair, and an aperiodic index). Unlike the speech synthesis device 1 according to the first embodiment, the key of the entry of the adjustment dictionaries of duration and each acoustic feature is the attribute information of the speech unit and the cluster number of the intermediate representation. The value of the entry of the adjustment dictionaries 271, 272, 273, 274, and 275 of duration and each acoustic feature is the adjustment instruction.

### Processing of Speech Synthesis Device 2

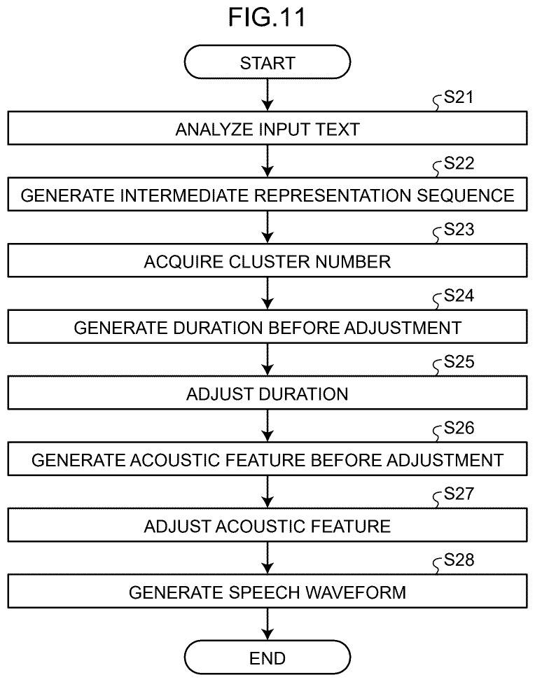

FIG. 11 is a flowchart illustrating an example of an overall procedure of a speech synthesis method according to the second embodiment. First, the analyzing unit 21 analyzes the input text and outputs the attribute information of each speech unit (step S21). Subsequently, the encoder 22 generates the intermediate representation sequence from the attribute information of each speech unit (step S22). Then, the index acquiring unit 26 acquires the cluster number from the intermediate representation sequence (step S23).

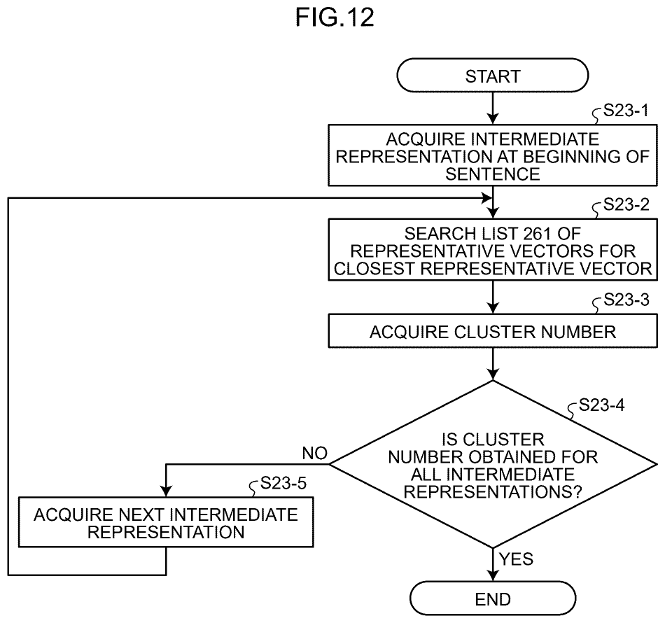

FIG. 12 is a flowchart illustrating an example of a detailed procedure of acquisition processing (step S23 in FIG. 11) of the cluster number according to the second embodiment. First, the index acquiring unit 26 acquires the intermediate representation at the beginning of the sentence (step S23-1), and searches the list 261 of the representative vectors of the clusters for the representative vector closest to the vector indicating the intermediate representation (step S23-2). Then, the index acquiring unit 26 acquires the number for the cluster represented by the representative vector obtained in step S23-2 (step S23-3).

When the acquisition of the cluster number has been completed for all the intermediate representations (Yes in step S23-4), the processing ends. If the acquisition of the cluster number has not been completed for all the intermediate representations (No in step S23-4), the index acquiring unit 26 acquires the next intermediate representation (step S23-5), and performs the processing from step (S23-2).

Returning to FIG. 11, subsequently, the duration decoder 23 receives the intermediate representation sequence as the input and generates the duration before adjustment (step S24). Next, the adjusting unit 27 adjusts the duration before adjustment obtained in step S24 based on the attribute information of each speech unit and the cluster number of each intermediate representation (step S25).

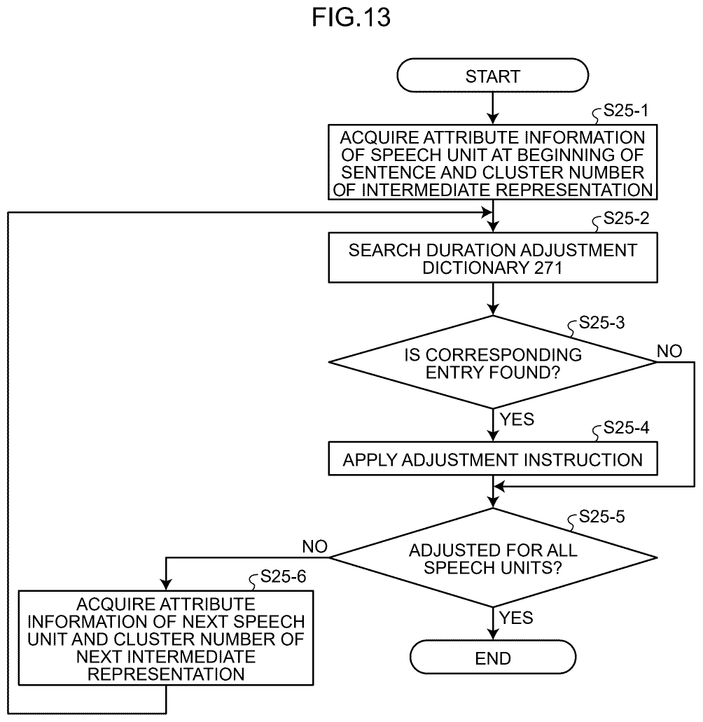

FIG. 13 is a flowchart illustrating an example of a detailed procedure of the adjustment processing (step S25 in FIG. 11) of the duration according to the second embodiment. First, the adjusting unit 27 acquires the attribute information of the speech unit at the beginning of the sentence and the cluster number of the intermediate representation (step S25-1), and searches the duration adjustment dictionary 271 for an entry in which the key (attribute information of the speech unit and cluster number) is matched (step S25-2). If a matched entry is found (Yes in step S25-3), the adjusting unit 27 applies the adjustment instruction of the entry to the duration corresponding to the attribute information of the speech unit acquired in step S25 (step S25-4). If no matched entry is found (No in step S25-3), the processing proceeds to step S25-5.

When the adjustment has been completed for all the speech units (Yes in step S25-5), the processing ends. If the adjustment has not been completed for all the speech units (No in step S25-5), the adjusting unit 27 acquires the attribute information of the next speech unit and the cluster number of the next intermediate representation (step S25-6), and performs the processing from step S25-2.

Returning to FIG. 11 again, subsequently, the acoustic feature decoder 24 generates each acoustic feature before adjustment from the intermediate representation sequence based on the duration after adjustment (step S26). Next, the adjusting unit 27 adjusts each acoustic feature from each acoustic feature before adjustment, the attribute information of each speech unit, and the cluster number of the intermediate representation (step S27).

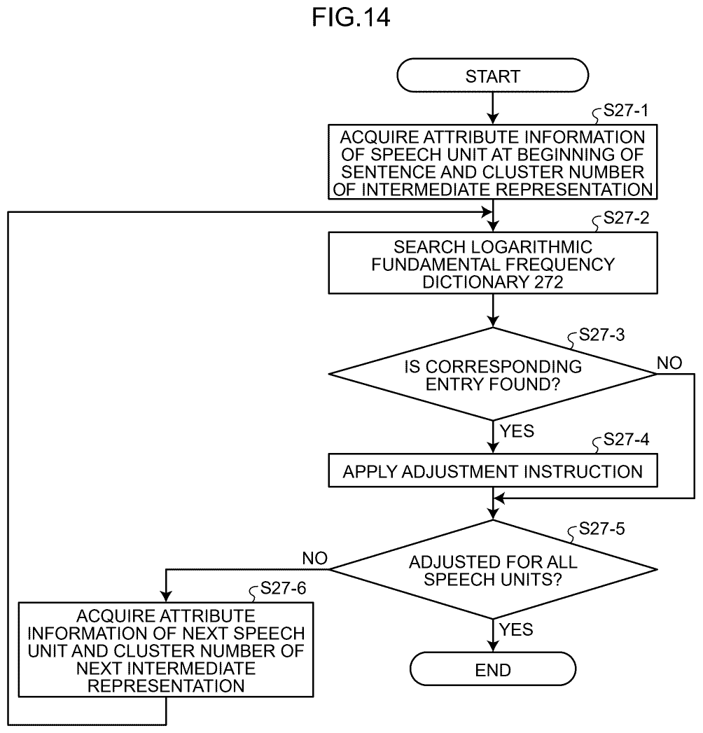

As an example, FIG. 14 illustrates details on the adjustment method of the logarithmic fundamental frequency. FIG. 14 is a flowchart illustrating an example of a detailed procedure of the adjustment processing (step S27 in FIG. 11) of the acoustic feature (in the case of a logarithmic fundamental frequency) according to the second embodiment. First, the adjusting unit 27 acquires the attribute information of the speech unit at the beginning of the sentence and the cluster number of the intermediate representation (step S27-1), and searches the logarithmic fundamental frequency adjustment dictionary 272 for an entry in which the key (attribute information of the speech unit and cluster number) is matched (step S27-2).

If a matched entry is found (Yes in step S27-3), the adjusting unit 27 applies the adjustment instruction of the entry to the section corresponding to the attribute information of the speech unit and the cluster number of the intermediate representation acquired in step S27-1 (step S27-4).

When the adjustment has been completed for all the speech units (Yes in step S27-5), the processing ends. If the adjustment has not been completed for all the speech units (No in step S27-5), the adjusting unit 27 acquires the attribute information of the next speech unit and the cluster number of the next intermediate representation (step S27-6), and performs the processing from step S27-2.

Note that the adjusting unit 27 also adjusts acoustic features other than the logarithmic fundamental frequency through the same processing as that in FIG. 14.

Returning to FIG. 11 again, finally, the vocoder 25 generates the speech waveform from the acoustic feature after adjustment obtained in step S27 (step S28).

### Details of Each Part of Speech Synthesis Device 2

The list 261 of the representative vectors of the clusters included in the index acquiring unit 26 is obtained by learning the clustering model in advance. For the clustering model, for example, a model is used that has been learned by using, as learning data, an intermediate representation obtained from each sentence used for learning of the neural network having the encoder/decoder structure used in the speech synthesis device 2 after the learning is completed. In addition, for example, a clustering model learned at the same time as the neural network having the encoder/decoder structure may be used by applying the learning method disclosed in A. Oord, O. Vinyals, and K. Kavukcuoglu, “Neural Discrete Representation Learning”, in Advances in Neural Information Processing Systems, vol. 30, 2017.

The reference of “closeness” when the index acquiring unit 26 searches for the representative vector is a distance scale when the clustering model is learned. For example, in a case where an L2 norm is used to learn the clustering model, the L2 norm is also used for searching for the representative vector. In addition, for example, in a case where cosine similarity is used for learning the clustering model, the cosine similarity is also used for searching for the representative vector.

In the second embodiment, the adjustment dictionaries 271, 272, 273, 274, and 275 of duration and each acoustic feature use the cluster number obtained when the intermediate representation is clustered as the key, in addition to the attribute information of the speech unit, thereby making it possible to specify an appropriate condition for applying the adjustment without specifying the attribute information of the speech unit in detail.

According to, for example, paragraph 0089 in JP 2022-81691 A, the attribute information of the speech unit is complicated information that needs to be represented by using a 312-dimensional binary value and 13-dimensional numerical data. Therefore, it may be difficult to appropriately set the section to which the adjustment instruction is applied only with the attribute information of the speech unit. However, it is considered that the intermediate representation appropriately encodes the attribute information of the speech unit, and the representative vector obtained by clustering the intermediate representations retains essential information of each intermediate representation. Therefore, by using the cluster number, it is possible to specify the appropriate condition for applying the adjustment without specifying the attribute information in detail.

In addition, the machine learning model used by the index acquiring unit 26 may be a decision tree model that receives the attribute information of the speech unit as the input and outputs the intermediate representation. In this case, the attribute information of the speech unit may be input to the index acquiring unit 26, and the arrival leaf node number of the decision tree may be used as the information identifying the intermediate representation instead of the cluster number. As in the case where the clustering model is used, the decision tree model is obtained, for example, by learning the intermediate representation obtained from each sentence used for learning of the neural network having the encoder/decoder structure used in the speech synthesis device 2 as the teaching data after the learning is completed.

### Effects of Speech Synthesis Device 2 of Second Embodiment

As described above, in the speech synthesis device 2 according to the second embodiment, the information identifying the intermediate representation is defined as an index that is obtained by using a machine learning model that classifies the intermediate representation or classifies the attribute information of the speech unit. With this configuration, the interpretability of the keys of the adjustment dictionaries 271, 272, 273, 274, and 275 (FIG. 10) of duration and each acoustic feature is improved as compared with, for example, the case where the intermediate representation is used as it is.

In other words, with the speech synthesis device 2 of the second embodiment, it is possible to specify the appropriate condition for applying the adjustment without specifying in detail the attribute information of the speech unit. For example, by further using the above-described cluster number (an example of the information identifying the intermediate representation output from the neural network) as the key, the interpretability of the key is improved while the key is kept compact. In addition, for example, by further using the above-described leaf node number (an example of the information identifying the intermediate representation output from the neural network) as the key, the interpretability of the key is improved while the key is kept compact.

### Third Embodiment

Next, a third embodiment will be described. In the description of the third embodiment, the same description as that of the first embodiment will be omitted, and parts different from the first embodiment will be described.

### Outline of Speech Synthesis Device 3

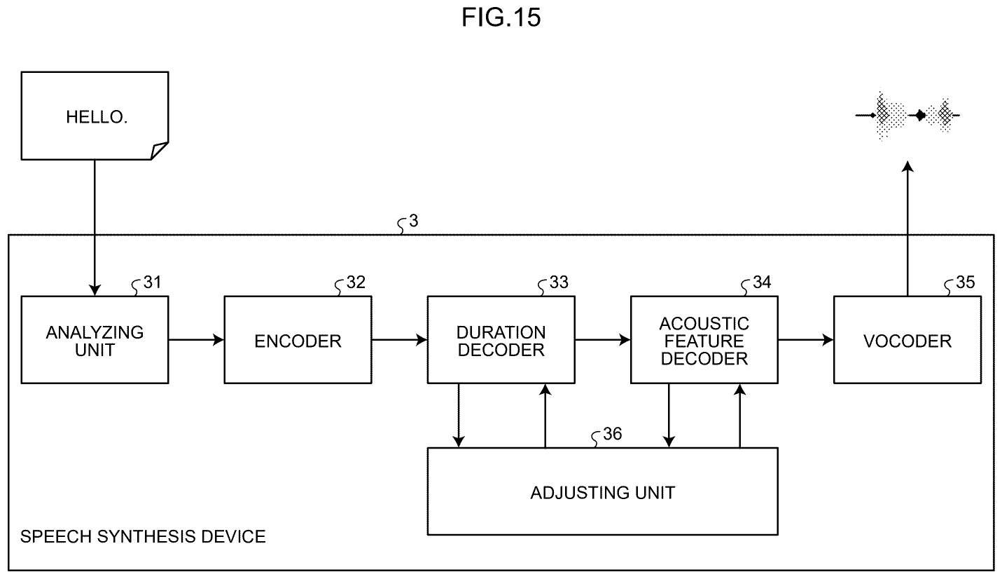

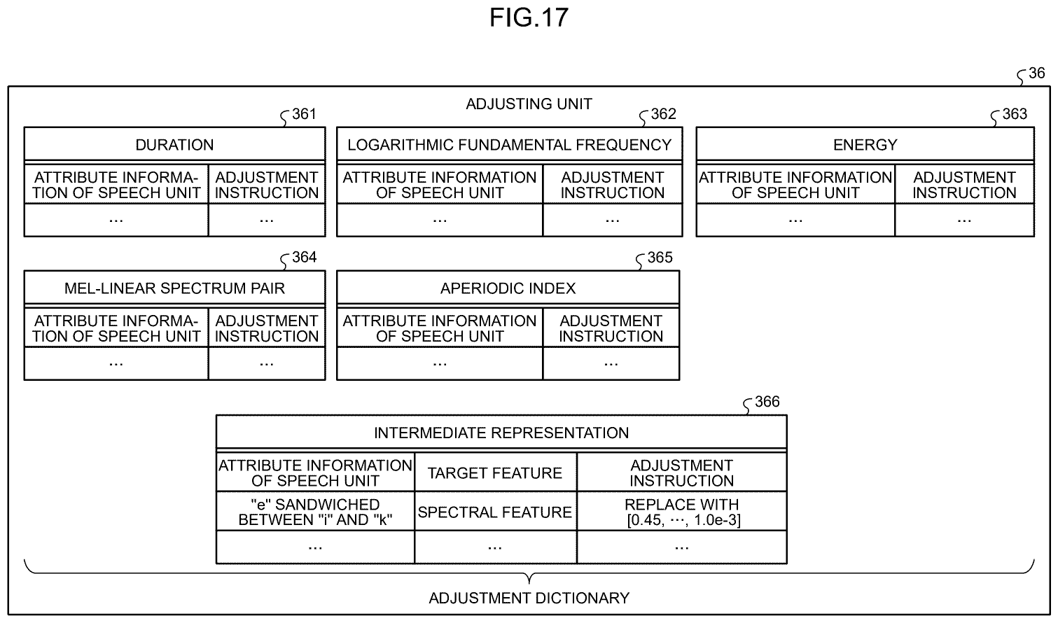

FIG. 15 is a diagram illustrating an example of a functional configuration of a speech synthesis device 3 according to the third embodiment. In the speech synthesis device 3 according to the third embodiment, an adjusting unit 36 also adjusts the intermediate representation in addition to the duration and the acoustic features. The adjusting unit 36 according to the third embodiment includes an intermediate representation adjustment dictionary 366 (FIG. 17). The intermediate representation adjustment dictionary 366 has the attribute information of the speech unit and the type of the acoustic feature to which the adjustment instruction is to be applied as the keys, and has the adjustment instruction to the intermediate representation as the value. By adjusting an intermediate representation generating misreading to an intermediate representation with a correct pronunciation, misreading can be efficiently adjusted.

In addition, by also using the type of the acoustic feature to which the adjustment instruction is to be applied as the key of the intermediate representation adjustment dictionary 366, it is possible to determine whether to apply the adjustment instruction of each entry for each type of the acoustic feature. Since the speech synthesis device 3 generates the duration and each acoustic feature from the same intermediate representation sequence output from an encoder 32, it is possible to suppress the influence on the duration or the acoustic feature irrelevant to misreading by determining whether or not to apply the adjustment instruction of each entry for each type of the acoustic feature.

Details of each functional block will be described below.

Similarly to the speech synthesis device 1 according to the first embodiment, the speech synthesis device 3 according to the third embodiment includes an analyzing unit 31, an encoder 32, a duration decoder 33, an acoustic feature decoder 34, a vocoder 35, and the adjusting unit 36. Each unit has the same function as that of the speech synthesis device 1 according to the first embodiment.

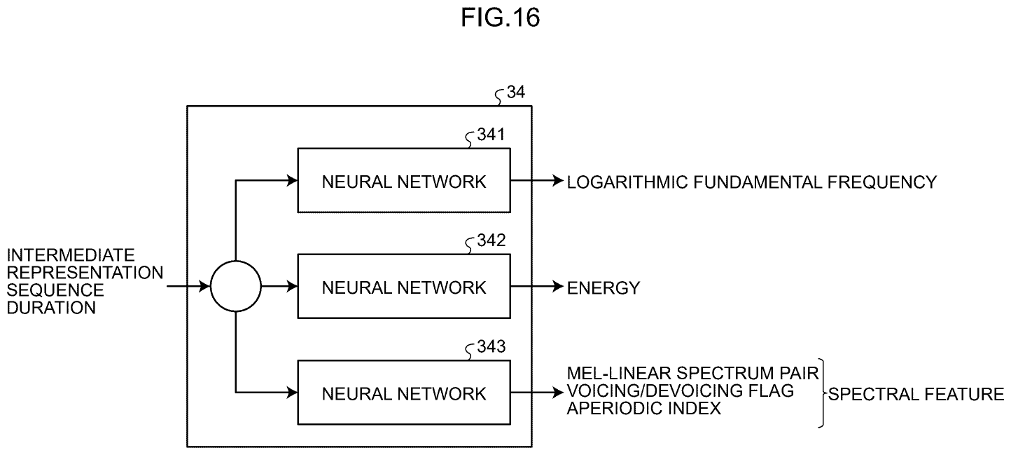

FIG. 16 is a diagram illustrating an example of a functional configuration of the acoustic feature decoder 34 according to the third embodiment. As illustrated in FIG. 16, the acoustic feature decoder 34 according to the third embodiment outputs the logarithmic fundamental frequency and the energy by using respective different neural networks 341 and 342, and outputs the mel-linear spectrum pair, the voicing/devoicing flag, and the aperiodic index by using the same neural network 343.

Hereinafter, the third embodiment uses four types of the acoustic feature: duration, a logarithmic fundamental frequency, energy, and a spectral feature. Here, the spectral feature as the type of the acoustic feature is a collective term for three acoustic features: the voicing/devoicing flag and the aperiodic index, in addition to the mel-linear spectrum pair that is a spectral feature output by using the neural network 343. Note that the type of the acoustic feature may include at least one of duration, a logarithmic fundamental frequency, energy, or a spectral feature.

FIG. 17 is a diagram illustrating an example of a functional configuration of the adjusting unit 36 according to the third embodiment. The adjusting unit 36 according to the third embodiment includes the intermediate representation adjustment dictionary 366 used for the adjustment of the intermediate representation, and adjustment dictionaries 361, 362, 363, 364, and 365 of each acoustic feature. The key of the adjustment dictionary 366 corresponding to the intermediate representation is the attribute information of the speech unit and a target acoustic feature name, and the value is an adjustment instruction to replace the intermediate representation with that with a specified vector.

### Processing of Speech Synthesis Device 3

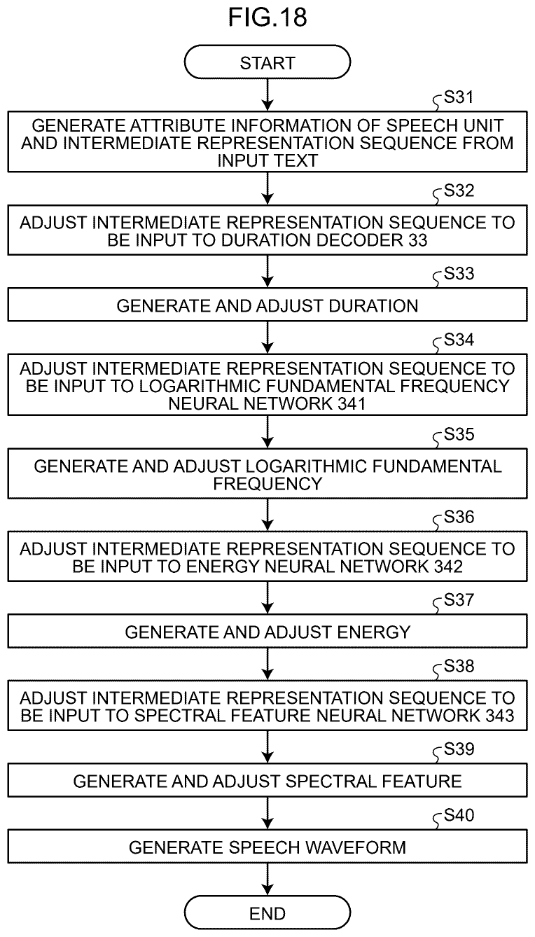

FIG. 18 is a flowchart illustrating an example of an overall procedure of a speech synthesis method according to the third embodiment. First, the analyzing unit 31 generates the attribute information of the speech unit from the input text, and the encoder 32 generates the intermediate representation sequence from the attribute information of the speech unit (step S31).

Subsequently, the adjusting unit 36 adjusts the intermediate representation sequence to be input to the duration decoder 33 (step S32). Then, the duration decoder 33 generates the duration from the intermediate representation sequence obtained in step S32, and the adjusting unit 36 adjusts the duration (step S33). Note that the detailed procedure of the adjustment processing in step S33 is the same as in the case of the speech synthesis device 1 according to the first embodiment (see FIG. 4).

Subsequently, the adjusting unit 36 adjusts the intermediate representation sequence to be input to the neural network 341 that outputs the logarithmic fundamental frequency (step S34). Then, the neural network 341 receives the input of the intermediate representation sequence obtained in step S34 and outputs the logarithmic fundamental frequency, and the adjusting unit 36 adjusts the logarithmic fundamental frequency (step S35). Note that the detailed procedure of the adjustment processing in step S5 is also the same as in the case of the speech synthesis device 1 according to the first embodiment (see FIG. 6).

Subsequently, the adjusting unit 36 adjusts the intermediate representation sequence to be input to the neural network 342 that outputs the energy (step S36). Then, the neural network 342 receives the input of the intermediate representation sequence obtained in step S36 and outputs the energy, and the adjusting unit 36 adjusts the energy (step S37). Note that the detailed procedure of the adjustment processing in step S37 is also the same as in the case of the speech synthesis device 1 according to the first embodiment.

Subsequently, the adjusting unit 36 adjusts the intermediate representation sequence to be input to the neural network 343 that outputs the spectral feature (step S38). Then, the neural network 343 receives the input of the intermediate representation sequence obtained in step S38 and outputs the spectral feature, and the adjusting unit 36 adjusts the spectral feature by adjusting the mel-linear spectrum pair and the aperiodic index of the spectral feature (step S39). Note that the detailed procedure of the adjustment processing in step S39 is also the same as in the case of the speech synthesis device 1 according to the first embodiment.

Finally, the vocoder 35 generates the speech waveform from the acoustic feature after adjustment obtained in the processing up to step S39 (step S40).

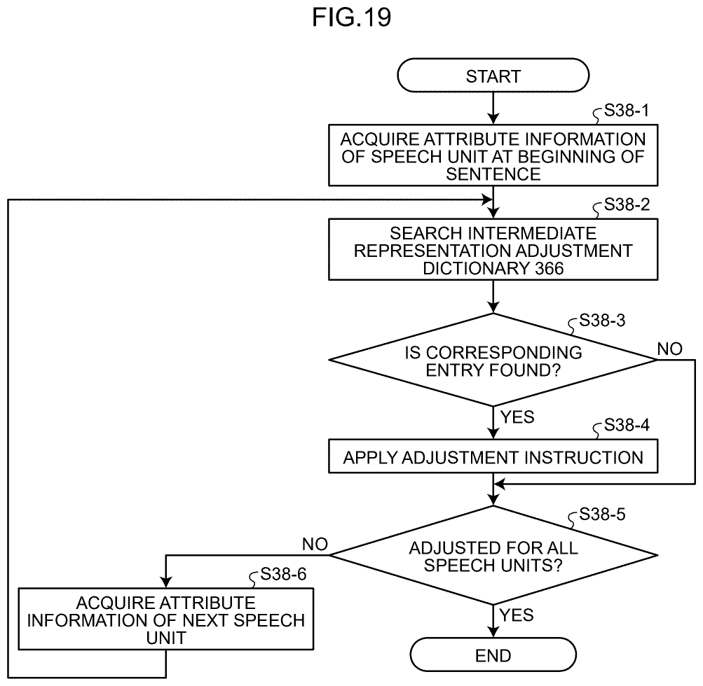

FIG. 19 illustrates details of the adjustment method of the intermediate representation sequence. FIG. 19 is a flowchart illustrating an example of a detailed procedure of the adjustment processing (step S38 in FIG. 18) of the intermediate representation sequence to be input to the neural network 343 that outputs the spectral feature according to the third embodiment. FIG. 19 illustrates the processing in step S38 as an example, but the same processing is also performed in step S32 in which the target acoustic feature is duration, step S34 in which the target acoustic feature is a logarithmic fundamental frequency, and step S36 in which the target acoustic feature is energy.

First, the adjusting unit 36 acquires the attribute information of the speech unit at the beginning of the sentence (step S38-1), and searches the intermediate representation adjustment dictionary 366 for an entry in which the attribute information of the speech unit is matched and the target acoustic feature is a spectral feature (step S38-2). If the entry is found (Yes in step S38-3), the adjusting unit 36 applies the adjustment instruction of the entry to the intermediate representation corresponding to the attribute information of the speech unit (step S38-4). If no entry is found (No in step S38-3), the processing proceeds to step S38-5.

When the adjustment has been completed for all the speech units (Yes in step S38-5), the processing ends. If the adjustment has not been completed for all the speech units (No in step S38-5), the adjusting unit 36 acquires the attribute information of the next speech unit (step S38-6), and performs the processing from step S32-2.

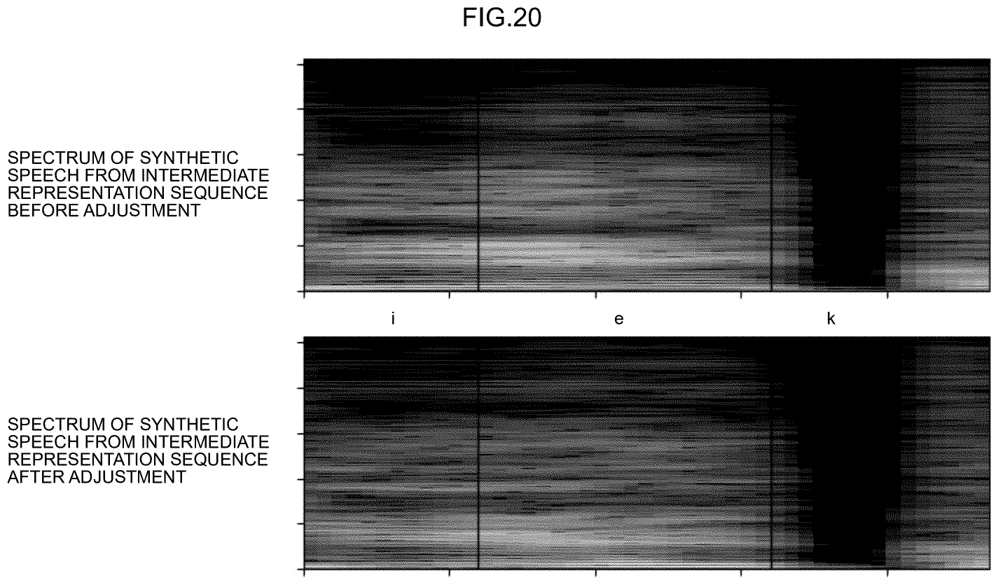

FIG. 20 is a diagram illustrating an example of a spectrum of synthetic speech in a case where the intermediate representation sequence has been adjusted through the adjustment processing (step S38 in FIG. 18) according to the third embodiment. The example of FIG. 20 illustrates an example of the spectrum of synthetic speech in a case where the speech unit is a phoneme and a sentence “Ki-e-ka-ta.” in Japanese language (corresponding to “Way of disappearing” in English language) is input. In this case, since the vowel “e” sandwiched between the vowel “i” and the consonant “k” is included, the first entry of the intermediate representation adjustment dictionary 366 is found during searching in the intermediate representation adjustment dictionary 366. Therefore, in step S38-4, the adjustment instruction to replace the intermediate representation with the vector (0.45, . . . , 1.0e-3) that is the value of the entry is applied. As a result, as illustrated in FIG. 20, the spectrum in the area corresponding to the vowel “e” is changed from that before adjustment.

As described above, in the third embodiment, by adjusting the intermediate representation generating misreading to the intermediate representation with a correct pronunciation, the misreading can be efficiently adjusted. In addition, by also using the acoustic feature to which the adjustment instruction is to be applied as the key of the intermediate representation adjustment dictionary 366, it is possible to determine whether to apply the adjustment instruction of each entry for each type of the acoustic feature. Since the speech synthesis device 3 according to the third embodiment outputs each acoustic feature from the same intermediate representation sequence output from the encoder 32, it is possible to suppress the influence on the acoustic feature irrelevant to misreading by determining whether to apply the adjustment instruction of each entry for each type of the acoustic feature.

### Details of Each Part of Speech Synthesis Device 3

The adjustment instruction of the intermediate representation adjustment dictionary 366 is, for example, an operation of replacing with a specified vector. As the specified vector, for example, a vector is used that indicates an intermediate representation corresponding to the speech unit of a sentence having no problem among sentences including the speech unit with the same reading. In addition, the vector is specified by directly specifying the vector in FIG. 17, but, for example, a list of replacement destination vectors may be created and the index may be specified as the replacement destination. In the latter case, during adjustment, the vector of the corresponding index may be read from the list of replacement destination vectors to replace the intermediate representation in the adjustment area.

### Effects of Speech Synthesis Device 3 of Third Embodiment

As described above, according to the speech synthesis device 3 of the third embodiment, the vector indicating the intermediate representation generating misreading is replaced with the specified vector, thereby adjusting to the intermediate representation with a correct pronunciation. With this configuration, misreading can be adjusted more efficiently. In addition, by also using the acoustic feature to which the adjustment instruction is to be applied as the key of the intermediate representation adjustment dictionary 366, it is possible to determine whether or not to apply the adjustment instruction of each entry for each type of the acoustic feature, and suppress the influence on the acoustic feature irrelevant to misreading.

### Supplement to Embodiments

Each of the speech synthesis devices 1, 2, and 3 according to the first to third embodiments includes one adjusting unit 16, 27, or 36, but may include a plurality of adjusting units. In one example, the adjusting unit corresponding to each of duration, an intermediate representation, and each acoustic feature may be provided.

In addition, in the speech synthesis devices 1, 2, and 3, each speech unit and the intermediate representation correspond to each other on a one-to-one basis, but each speech unit and the intermediate representation may correspond to each other on a one-to-multiple basis. In this case, the adjustment dictionaries 161, 267, and 361 may further use the number for the intermediate representation corresponding to the speech unit as the key. By doing so, for example, in a case where each speech unit and the intermediate representation correspond to each other on a one-to-two basis, it is possible to specify and adjust, for example, the acoustic feature corresponding to the first intermediate representation or such an intermediate representation.

Finally, an example of a hardware configuration of the speech synthesis devices 1, 2, and 3 according to the first to third embodiments will be described.

### Example of Hardware Configuration

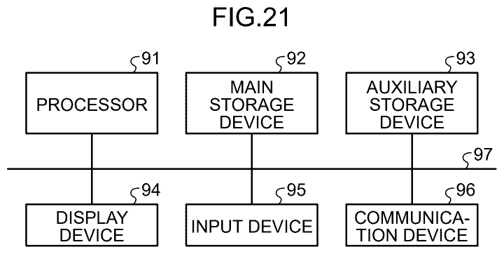

FIG. 21 is a diagram illustrating an example of the hardware configuration of the speech synthesis devices 1, 2, and 3 according to the first to third embodiments. The speech synthesis devices 1, 2, and 3 each include a processor 91, a main storage device 92, an auxiliary storage device 93, a display device 94, an input device 95, and a communication device 96. The processor 91, the main storage device 92, the auxiliary storage device 93, the display device 94, the input device 95, and the communication device 96 are connected via a bus 97.

Note that the speech synthesis devices 1, 2, and 3 may not include part of the above-described configuration. For example, in a case where the speech synthesis devices 1, 2, and 3 can use an input function and a display function of an external device, the speech synthesis devices 1, 2, and 3 may not include the display device 94 and the input device 95.

The processor 91 executes a program read from the auxiliary storage device 93 to the main storage device 92. The main storage device 92 is a memory such as a ROM and a RAM. The auxiliary storage device 93 is a hard disk drive (HDD), a memory card, or the like.

The display device 94 is, for example, a liquid crystal display or the like. The input device 95 is an interface for operating the speech synthesis device 1 (2,3). Note that the display device 94 and the input device 95 may be implemented by a touch panel or the like having the display function and the input function. The communication device 96 is an interface for communicating with other devices.

In addition, for example, the program executed by the speech synthesis device 1 (2,3) may be stored on a computer connected to a network such as the Internet and provided by being downloaded via the network.

Furthermore, for example, the program executed by the speech synthesis device 1 (2,3) may be provided via the network such as the Internet without being downloaded. Specifically, speech synthesis processing may be executed by a so-called application service provider (ASP) type service that implements a processing function only through execution instruction and result acquisition without transferring the program from the server computer.

In addition, for example, the program of the speech synthesis device 1 (2,3) may be provided by being incorporated in advance in the ROM or the like. The program may be provided as a computer program product that is obtained by recording the program with a file in an installable or executable format on a non-transitory computer readable recording medium such as a compact disk read only memory (CD-ROM), a flexible disk (FD), a compact disk recordable (CD-R), or a digital versatile disk (DVD).

The program executed by the speech synthesis device 1 (2,3) has a module configuration including a function that can also be implemented by the program in the above-described functional configuration. When implementing each function as actual hardware, the processor 91 reads the program from the storage medium and executes the program, thereby loading each of the above-described functional blocks on the main storage device 92. Thus, each of the above-described functional blocks is created on the main storage device 92.

Note that some or all of the above-described functions may not be implemented by software but may be implemented by one or more pieces of hardware such as an integrated circuit (IC).

In addition, each function may be implemented by using plural processors 91. In this case, each processor 91 may implement one of the functions or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech synthesis device comprising:
a memory; and
a hardware processor connected to the memory and configured to
execute encoder processing with a first neural network to convert attribute information of a speech unit into an intermediate representation,
execute decoder processing with a second neural network to generate an acoustic feature from the intermediate representation, and
execute adjustment processing by
using an adjustment dictionary in which at least the attribute information of the speech unit is set as a key and an adjustment instruction to the acoustic feature is set as a value,
defining, by the key, a section to which the adjustment instruction is applied, and
adjusting the acoustic feature in the defined section based on the adjustment instruction.

2. The speech synthesis device according to claim 1, wherein the key of the adjustment dictionary includes information identifying the intermediate representation obtained by the first neural network.

3. The speech synthesis device according to claim 2, wherein
the intermediate representation is a latent representation obtained by the encoder processing, and
the information identifying the intermediate representation is an index obtained by using a machine learning model that classifies the intermediate representation or the attribute information of the speech unit.

4. The speech synthesis device according to claim 3, wherein
the machine learning model that classifies the intermediate representation is a clustering model, and
the index is a cluster number obtained when the intermediate representation is classified by the clustering model.

5. The speech synthesis device according to claim 3, wherein
the machine learning model that classifies the attribute information of the speech unit is a decision tree model, and
the index is a leaf node number reached when the attribute information of the speech unit is input to the decision tree model.

6. The speech synthesis device according to claim 1, wherein the adjustment instruction is an instruction to replace a vector indicating the intermediate representation with a specified vector.

7. The speech synthesis device according to claim 6, wherein the instruction to replace with the specified vector is defined for each type of the acoustic feature.

8. The speech synthesis device according to claim 7, wherein the type of the acoustic feature includes at least one of duration of the speech unit, a logarithmic fundamental frequency, energy, or a spectral feature.

9. The speech synthesis device according to claim 1, wherein
the acoustic feature is a logarithmic fundamental frequency, and
the adjustment instruction is an instruction to apply a specified operation to the logarithmic fundamental frequency.

10. The speech synthesis device according to claim 1, wherein
the acoustic feature is duration of the speech unit, and
the adjustment instruction is an instruction to apply a specified operation to the duration.

11. The speech synthesis device according to claim 1, wherein
the acoustic feature is energy, and
the adjustment instruction is an instruction to apply a specified operation to the energy.

12. The speech synthesis device according to claim 1, wherein
the acoustic feature is a spectral feature, and
the adjustment instruction is an instruction to apply a specified operation to the spectral feature.

13. The speech synthesis device according to claim 1, wherein
the acoustic feature is an aperiodic index, and
the adjustment instruction is an instruction to apply a specified operation to the aperiodic index.

14. A speech synthesis method implemented by a computer, the method comprising:
executing encoder processing with a first neural network to convert attribute information of a speech unit into an intermediate representation;
executing decoder processing with a second neural network to generate an acoustic feature from the intermediate representation; and
executing adjustment processing by
using an adjustment dictionary in which at least the attribute information of the speech unit is set as a key and an adjustment instruction to the acoustic feature is set as a value,
defining, by the key, a section to which the adjustment instruction is applied, and
adjusting the acoustic feature in the defined section based on the adjustment instruction.

15. A computer program product comprising a non-transitory computer readable recording medium on which programmed instructions executable by a computer are recorded, the instructions causing the computer to perform processing, the processing including:
executing encoder processing with a first neural network to convert attribute information of a speech unit into an intermediate representation;
executing decoder processing with a second neural network to generate an acoustic feature from the intermediate representation; and
executing adjustment processing by
using an adjustment dictionary in which at least the attribute information of the speech unit is set as a key and an adjustment instruction to the acoustic feature is set as a value,
defining, by the key, a section to which the adjustment instruction is applied, and
adjusting the acoustic feature in the defined section based on the adjustment instruction.
